(19) United States
(12) Patent Application Publication
(10) Pub. No.: US 2021/0150239 A1
(43) Pub. Date: May 20, 2021

(54) ANTI-SPOOFING DETECTION USING SINGLE ELEMENT TRANSCEIVER

(71) Applicant: QUALCOMM Incorporated, San Diego, CA (US)

(72) Inventors: Soon Joon Yoon, San Jose, CA (US); Changting Xu, Santa Clara, CA (US); Hrishikesh Panchawagh, Cupertino, CA (US); Kostadin Dimitrov Djordjev, Los Gatos, CA (US)

(21) Appl. No.: 16/686,063

(22) Filed: Nov. 15, 2019

(51) Int. Cl. G06K 9/00; G06F 21/32; H04L 29/06

(52) U.S. Cl. CPC G06K 9/00906; G06F 21/32; G06K 9/00026; G06K 2009/0006; G06K 9/00087; H04L 63/0861; G06K 9/00033

(57) ABSTRACT

Methods, systems, and devices for anti-spoofing detection are described. The methods, systems, and devices include scanning, by a sensor associated with a device, an object placed within a scanning distance of the sensor, identifying a test signal based on scanning the object, comparing the test signal to a reference signal, identifying a first match between the object and a biometric model based on the comparing, identifying, based on the scanning, a second match between a first biometric pattern associated with the object and a stored second biometric pattern, and enabling access to a secure resource associated with the device based on the first match and the second match.

### BACKGROUND

The following relates generally to anti-spoofing detection, and more specifically to anti-spoofing detection using a single element transceiver.

The use of computer systems and computer-related technologies continues to increase at a rapid pace. The expansive use of computer systems has influenced the advances made to computer-related technologies. Computer systems have increasingly become an integral part of the business world and the activities of individual consumers. Computer systems may be used to carry out several business, industry, and academic endeavors.

The widespread use of computers and mobile devices has caused an increased presence in malicious behavior including authentication spoofing, data theft, embedding malware, and the like. Due to the adapted methods and implementations imposed by authentication spoofing, security methods for securing and restricting access to sensitive resources may be beneficial in detecting authentication spoofing and mitigating authentication spoofing attempts.

### SUMMARY

The described techniques relate to improved methods, systems, devices, and apparatuses that support anti-spoofing detection using a single element transceiver. Generally, the described techniques provide for using biometric authentication to control access to secure computer resources. The described techniques include scanning objects to determine whether the objects are genuine biometric objects and to determine whether a biometric pattern (e.g., fingerprint) generated from the scan of the object matches a previously captured biometric pattern. Access to the secure computer resources may be controlled based on these determinations.

A method of biometric anti-spoofing at a device is described. The method may include scanning, by a sensor associated with the device, an object placed within a scanning distance of the sensor, identifying a test signal based on scanning the object, comparing the test signal to a reference signal, identifying a first match between the object and a biometric model based on the comparing, identifying, based on the scanning, a second match between a first biometric pattern associated with the object and a stored second biometric pattern, and enabling access to a secure resource associated with the device based on the first match and the second match.

An apparatus for biometric anti-spoofing at a device is described. The apparatus may include a processor, memory coupled with the processor, and instructions stored in the memory. The instructions may be executable by the processor to cause the apparatus to scan, by a sensor associated with the device, an object placed within a scanning distance of the sensor, identify a test signal based on scanning the object, compare the test signal to a reference signal, identify a first match between the object and a biometric model based on the comparing, identify, based on the scanning, a second match between a first biometric pattern associated with the object and a stored second biometric pattern, and enable access to a secure resource associated with the device based on the first match and the second match.

Another apparatus for biometric anti-spoofing at a device is described. The apparatus may include means for scanning, by a sensor associated with the device, an object placed within a scanning distance of the sensor, identifying a test signal based on scanning the object, comparing the test signal to a reference signal, identifying a first match between the object and a biometric model based on the comparing, identifying, based on the scanning, a second match between a first biometric pattern associated with the object and a stored second biometric pattern, and enabling access to a secure resource associated with the device based on the first match and the second match.

A non-transitory computer-readable medium storing code for biometric anti-spoofing at a device is described. The code may include instructions executable by a processor to scan, by a sensor associated with the device, an object placed within a scanning distance of the sensor, identify a test signal based on scanning the object, compare the test signal to a reference signal, identify a first match between the object and a biometric model based on the comparing, identify, based on the scanning, a second match between a first biometric pattern associated with the object and a stored second biometric pattern, and enable access to a secure resource associated with the device based on the first match and the second match.

In some examples of the method, apparatuses, and non-transitory computer-readable medium described herein, scanning the object may include operations, features, means, or instructions for emitting a first transmit signal of a first frequency toward the object, and analyzing a reflected signal based on a reflection of the first transmit signal off of the object, where identifying the test signal may be based on analyzing the reflected signal.

Some examples of the method, apparatuses, and non-transitory computer-readable medium described herein may further include operations, features, means, or instructions for emitting a second transmit signal of a second frequency at the object, where the second transmit signal may be emitted after the first transmit signal or simultaneously with the first transmit signal, and where the second frequency may be different from the first frequency.

Some examples of the method, apparatuses, and non-transitory computer-readable medium described herein may further include operations, features, means, or instructions for analyzing a reflected signal based on a reflection of the first transmit signal off of the object and a reflection of the second transmit signal off of the object after the reflection of the first transmit signal, or based on the reflection of the first transmit signal combined with the second transmit signal off of the object, where identifying the test signal may be based on analyzing the reflected signal.

In some examples of the method, apparatuses, and non-transitory computer-readable medium described herein, comparing the test signal to the reference signal may include operations, features, means, or instructions for determining a cross-correlation between the reference signal and the test signal to determine a degree of difference between the test signal and the reference signal, and determining the test signal matches the reference signal when the degree of difference may be below a certain threshold.

Some examples of the method, apparatuses, and non-transitory computer-readable medium described herein may further include operations, features, means, or instructions for identifying a material type associated with the object based on the test signal matching the reference signal, where the reference signal may be associated with the identified material type, and where the enabling of access to the secure resource may be based on the identified material type matching a certain material type.

Some examples of the method, apparatuses, and non-transitory computer-readable medium described herein may further include operations, features, means, or instructions for identifying a penetration depth the first transmit signal penetrates the object based on comparing an aspect of the test signal to an aspect of the first transmit signal, and determining that the identified penetration depth correlates to the identified material type associated with the object, where the enabling of access to the secure resource may be based on determining the identified penetration depth correlates to the identified material type associated with the object.

Some examples of the method, apparatuses, and non-transitory computer-readable medium described herein may further include operations, features, means, or instructions for identifying a temperature of the object in conjunction with scanning the object, and determining that the temperature of the object may be within an expected temperature range for the object, where the enabling of access to the secure resource may be based on determining the temperature of the object may be within the expected temperature range for the object.

In some examples of the method, apparatuses, and non-transitory computer-readable medium described herein, the first biometric pattern includes one or more images of a finger, or of a fingerprint, or of an eye, or of an iris, or of a retina, or of a face, or of a palm, or of an ear, or of a vein, or of a pattern of veins, or any combination thereof, and where the second biometric pattern includes one or more images of a finger, or of a fingerprint, or of an eye, or of an iris, or of a retina, or of a face, or of a palm, or of an ear, or of a vein, or of a pattern of veins, or any combination thereof.

In some examples of the method, apparatuses, and non-transitory computer-readable medium described herein, an aspect of the first transmit signal, or the second transmit signal, or the test signal, or the reference signal includes at least one of a wavelength, or an amplitude, or a period, or a phase, or a signal frequency, or a harmonic frequency, or a signal strength, or an attenuation constant, or a transmit time, or a receive time, or a delay time, or any combination thereof.

In some examples of the method, apparatuses, and non-transitory computer-readable medium described herein, a determination to enable the access to the secure resource may be made within a time period associated with one or two emissions of at least the first transmit signal.

Some examples of the method, apparatuses, and non-transitory computer-readable medium described herein may further include operations, features, means, or instructions for blocking access to the secure resource based on the object not matching the biometric model, or the first biometric pattern of the object not matching the second biometric pattern.

In some examples of the method, apparatuses, and non-transitory computer-readable medium described herein, the sensor may be a piezoelectric copolymer based biometric sensor, where the sensor may be integrated in a display of the device.

In some examples of the method, apparatuses, and non-transitory computer-readable medium described herein, the sensor may be integrated in a display of the device.

### BRIEF DESCRIPTION OF THE DRAWINGS

FIG. 1 illustrates an example of a system for anti-spoofing detection that supports anti-spoofing detection using a single element transceiver in accordance with aspects of the present disclosure.

FIG. 2 illustrates an example of a system that supports anti-spoofing detection using a single element transceiver in accordance with aspects of the present disclosure.

FIG. 3 illustrates an example of a flowchart that supports anti-spoofing detection using a single element transceiver in accordance with aspects of the present disclosure.

FIGS. 4 and 5 show block diagrams of devices that support anti-spoofing detection using a single element transceiver in accordance with aspects of the present disclosure,

FIG. 6 shows a block diagram of an anti-spoofing manager that supports anti-spoofing detection using a single element transceiver in accordance with aspects of the present disclosure.

FIG. 7 shows a diagram of a system including a device that supports anti-spoofing detection using a single element transceiver in accordance with aspects of the present disclosure.

FIGS. 8 and 9 show flowcharts illustrating methods that support anti-spoofing detection using a single element transceiver in accordance with aspects of the present disclosure.

### DETAILED DESCRIPTION

To provide a relatively high level of security and enhanced authentication experience, anti-spoofing and liveness detection are important features for biometric authentication. Some liveness detection methods using physiological information require relatively long times to make a liveness determination. However, liveness detection should be achieved quickly to provide a satisfactory user experience.

In some cases, the present techniques may include a device with one or more sensors (e.g., biometric sensor, image sensor) for anti-spoofing and liveness detection. In some cases, the one or more sensors may include a piezoelectric copolymer-based biometric sensor. In some cases, the present techniques implements custom circuitry (e.g., application specific integrated circuits (ASICs), field programmable gate arrays (FPGAs), etc.). In some cases, the present techniques include a single element radio frequency (RF( front end.

In some examples, to detect spoofing the one or more sensors may be configured to detect and measure a frequency response (e.g., received waveforms) measured in response to firing one or more transmit signals of one or more frequencies at an object under test. The object under test may be any object within a detectable distance of the one or more sensors. In one example, the present technique may include determining whether the object under test is a biometric object (e.g., finger, eye, retina, iris, face, palm, ear, vein, etc.). In some cases, the present techniques may include determining whether an image of the object under test matches a biometric pattern.

In some cases, the present techniques prevent spoofing based on analysis of biometric-specific waveforms. In one example, biometric objects may be characterized based on specific driving schemes stimuli). The specific driving schemes may include one or more transmit signals fired by the device upon the object under test. The present techniques may include the device measuring resulting waveforms received by the device as a result of the one or more transmit signals emitted by the device. In some examples, each characterized material may provide different frequency responses to the specific driving schemes used to characterize the materials. In some cases, the frequency responses may be used to detect real material and spoof material by comparing one or more attributes (e.g., cross correlation, area under envelope) associated with the frequency response of the object under test and the frequency response of characterized materials.

In some cases, the sensor may include a single-element transceiver sensor (e.g., single signal transmitter and single signal receiver) that identifies waveforms associated with material-specific information in response to certain driving schemes. Each characterized material may have its own frequency dependent absorption characteristics. Thus, the sensor may identify waveforms associated with depth-specific information in response to certain driving schemes.

In some cases, the frequency response may include the device detecting one or more harmonic signals in the received waveforms and using the detected harmonic signals to determine whether an object under test is a biometric object. In some cases, the device may use temperature dependent signal characteristics for anti-spoof detection. For example, the one or more sensors may include a temperature sensor. In some cases, the frequency response receive waveforms) for certain biometric objects may be different from other materials at specific driving schemes. For example, the receive waveforms detected from scanning a finger may be different from the receive waveforms from scanning another biometric object or a spoofed biometric object. In some cases, the device may perform anti-spoofing detection within 1 or 2 firings of the transmitter (e.g., 1 or 2 emissions of a transmit signal).

The present techniques improve the speed of detection and improve the accuracy of anti-spoofing detection. Based on the present techniques, the detection of a real biometric object or a spoofed biometric object may be detected within emitting one or two transmit signals associated with scanning the biometric object.

Aspects of the disclosure are initially described in the context of anti-spoofing systems. Aspects of the disclosure are further illustrated by and described with reference to apparatus diagrams, system diagrams, and flowcharts that relate to anti-spoofing detection using a single element transceiver.

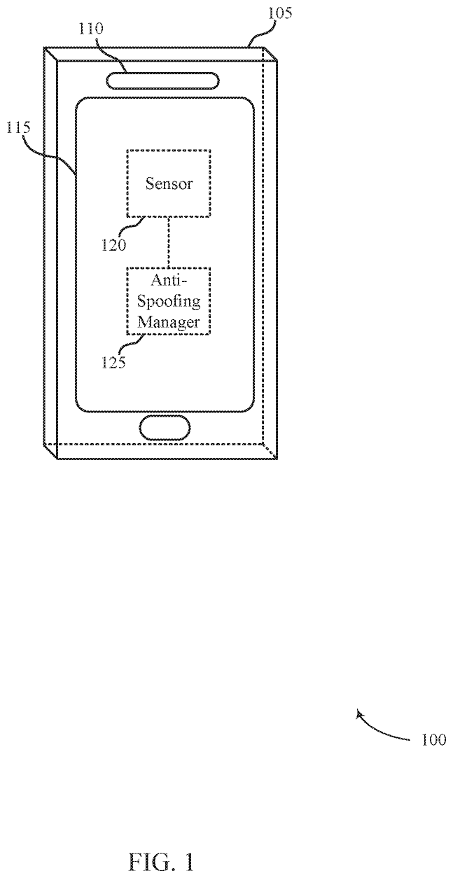

FIG. 1 illustrates an example of a system 100 for anti-spoofing detection. In the illustrated example, system 100 includes a device 105. Examples of device 105 may include a smart phone device, a personal digital assistant, a tablet computer, a laptop computer, a desktop computer, a handheld audio recording device, or any combination thereof. As shown, device 105 may include an interface 110, a display 115, a sensor 120, and anti-spoofing manager 125. In some cases, interface 110 may include a speaker, or a microphone, or a camera, a proximity sensor, or any combination thereof. Examples of sensor 120 may include biometric sensors e.g., piezoelectric copolymer-based biometric sensor), or image sensors, or proximity sensors, or any combination thereof. In some cases, sensor 120 may include multiple sensors. In some cases, sensor 120 may include multiple sensors integrated into a single package or a single chip. In some cases, sensor 120 may be integrated with display 115. In some cases, sensor 120 may sense or scan objects through display 115.

In some examples, anti-spoofing manager 125, in conjunction with sensor 120, may be configured to scan an object placed within a scanning distance of sensor 120 and to identify a test signal based at least in part on scanning the object. In some examples, anti-spoofing manager 125, in conjunction with sensor 120, may be configured to compare the test signal to a reference signal. In some cases, the reference signal may be obtained from an object characterization process that is performed by anti-spoofing manager 125, in conjunction with sensor 120, prior to the scanning of the object. In some cases, the reference signal may be part of a biometric model of an object (e.g., a biometric object such as a finger, an eye, a face, etc.) characterized prior to the scanning of the object. In some examples, anti-spoofing manager 125, in conjunction with sensor 120, may be configured to identify a first match between the object and a previously determined biometric model based at least in part on the comparing of the test signal (e.g., one or more attributes of received waveforms or reflected waveforms obtained from the scanning of the object) to the reference signal (e.g., one or more attributes of received waveforms or reflected waveforms obtained from a biometric model generated prior to the scanning of the object). In some cases, identifying the test signal is based at least in part on analyzing one or more reflected signals.

In some examples, anti-spoofing manager 125, in conjunction with sensor 120, may be configured to identify, based on the scanning, a second match between a first biometric pattern associated with the object and a stored second biometric pattern. In one example, the object may be a finger. In some cases, scanning the finger may include identifying a biometric pattern (e.g., fingerprint) of the finger. Thus, anti-spoofing manager 125, in conjunction with sensor 120, may be configured to determine whether a fingerprint of the finger matches a stored fingerprint of the finger. For example, prior to scanning the finger anti-spoofing manager 125, in conjunction with sensor 120, may analyze the finger being scanned and generate a biometric model of the finger based on the prior analysis. In some cases, the prior analysis may include obtaining a fingerprint of the finger and storing the fingerprint as a biometric pattern associated with the biometric model of the finger.

In some examples, anti-spoofing manager 125, in conjunction with sensor 120, may build the biometric model of an object by emitting at least a first transmit signal of at least a first frequency toward or at the object and analyzing one or more reflected signals that result from one or more reflections of the first transmit signal off of the object. In some cases, anti-spoofing manager 125, in conjunction with sensor 120, may build the biometric model of the object based on one or more attributes of the reflected signals determined from the analysis of the reflected signals. In some examples, the anti-spoofing manager 125, in conjunction with sensor 120, may scan the object after building the biometric model of the object, and the scanning of the object may include emitting at least the first transmit signal of at least the first frequency toward the object and analyzing one or more reflected signals that result from at least a portion of the first transmit signal reflecting off of the object, determining one or more attributes of the reflected signals based on the analysis of the reflected signals, and determining whether the one or more attributes of the reflected signals obtained from scanning the object match the one or more attributes associated with the biometric model of the previously analyzed object.

In some examples, anti-spoofing manager 125, in conjunction with sensor 120, may grant access to a secure resource associated with device 105 based at least in part on the first match between attributes obtained from the scan of the object and attributes obtained from the previously determined biometric model, or the second match between the first biometric pattern obtained from the scan of the object and a previously stored second. biometric pattern associated with the previously determined biometric model, or based on the first match and the second match.

The described operations of anti-spoofing manager 125, in conjunction with sensor 120, improve the speed of detection (e.g., anti-spoofing detection or live detection, or both). For example, the detection of a real biometric object or a spoofed biometric object may be detected by anti-spoofing manager 125, in conjunction with sensor 120, within the time it takes sensor 120 to emit one or two transmit signals (e.g., transmit signals emitted in association with scanning an object). The described operations of anti-spoofing manager 125, in conjunction with sensor 120, improve the accuracy of detection (e.g., anti-spoofing detection or live detection, or both). For example, when scanning a finger, anti-spoofing manager 125, in conjunction with sensor 120, not only determines whether a fingerprint of the finger matches a previously stored fingerprint of the finger, but also determines whether a frequency response of the finger matches a previously determined frequency response (e.g., biometric model) of the finger or fingers in general.

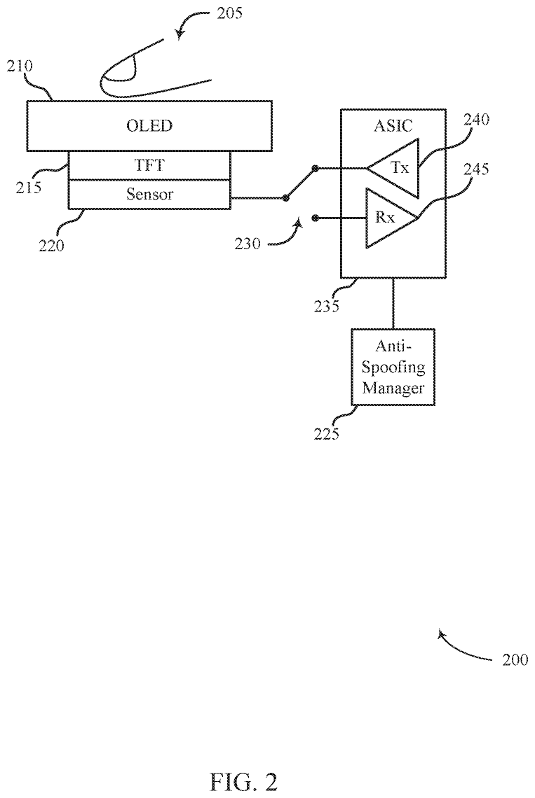

FIG. 2 illustrates an example of a system 200 that supports anti-spoofing detection using a single element transceiver in accordance with aspects of the present disclosure. In some examples, system 200 may implement aspects of system 100.

In the illustrated example, system 200 includes an object 205 (e.g., a finger or biometric object in the illustrated example), an organic light emitting diode (OLED) panel (e.g., OLED 210), an array of thin film transistors (TFTs) (e.g., TFT 215), and a sensor 220. In the illustrated example, sensor 220 may connect to a switch 230. In some cases, switch 230 may connect to at least one custom processor (e.g., application specific integrated circuit (ASIC) 235), and ASIC 235 may connect to anti-spoofing manager 225. As shown, ASIC 235 may include transmitter 240 and receiver 245. In some cases, transmitter 240 and receiver 245 may be part of a transceiver (e.g., single element transceiver). In some cases, sensor may include an image sensor, or a biometric sensor (e.g., a copolymer piezoelectric sensor), or a proximity sensor, or any combination thereof In some cases, at least a portion of system 200 may be part of a device (e.g., device 105 of FIG. 1). In some cases, sensor 220 may be an example of sensor 120 of FIG. 1, and OLED 210 and TFT 215 may be examples of components of display 115 of FIG. 1.

In some examples, sensor 220 may be configured to detect objects within a particular distance of OLED 210, or TFT 215, or sensor 220. In the illustrated example, sensor 220 may detect object 205 based on a proximity of object 205 relative to OLED 210, or TFT 215, or sensor 220. After detecting object 205, sensor 220 may determine whether object 205 is an actual biological object (e.g., finger, palm, eye, retina, iris, ear, face, etc.) or a spoofed biological object (e.g., a fake finger, a fake eye, etc.)

In some cases, ASIC 235, in conjunction with sensor 220, may scan object 205 after ASIC 235 determines object 205 is within a scanning distance of sensor 220. In some examples, sensor 220 may include a proximity sensor that monitors a spatial area relative to sensor 220 and enables ASIC 235 to determine whether an object is within a scanning distance of sensor 220.

In some examples, ASIC 235 may identify a test signal based on scanning object 205. In some cases, transmitter 240 may generate a first transmit signal of at least a first frequency and sensor 220 may emit the first transmit signal at object 205. In some cases, ASIC 235 may adjust switch 230 from transmitter 240 to receiver 245 after sensor 220 emits at least the first transmit signal. In some cases, at least a portion of the first transmit signal may reflect or bounce off of object 205 and sensor 220 may receive one or more of these reflected signals. In some cases, ASIC 235 identifying the test signal may be based on ASIC 235 measuring the reflected signals. In some cases, ASIC 235 may test or analyze one or more of the reflected signals, and at least one of the reflected signals tested by ASIC 235 may be referred to as a test signal.

In some examples, ASIC 235 may compare the test signal to a reference signal. In some cases, ASIC 235 comparing the test signal to the reference signal may include ASIC 235 determining a cross-correlation between the reference signal and the test signal, enabling ASIC 235 to determine a degree of difference between the test signal and the reference signal. In some cases, ASIC 235 may determine the test signal matches the reference signal when the degree of difference is below a certain threshold. In some cases, ASIC 235 may identify a first match between object 205 and a biometric model based on the comparing.

In some cases, the biometric model may include one or more waveforms (e.g., reference signals) that are based on sensor 220 emitting one or more transmit signals at one or more reference objects (e.g., inanimate object, animate object, organic object, inorganic object, biometric object, etc.) prior to scanning object 205. In some cases, transmitter 240 may generate a first transmit signal of at least a first frequency and sensor 220 may emit the first transmit signal toward a reference object, resulting in one or more receive signals being received or detected by sensor 220 and receiver 245 and analyzed by ASIC 235. For example, a reflected signal (e.g., waveform) may be analyzed by ASIC 235 based on one or more reflections of the first transmit signal off of the reference object. A biometric model that characterizes the reference object may be generated by ASIC 235 based on the analysis of the reflected signals. For example, sensor 220 may emit at least a first transmit signal of at least a first frequency at a reference finger and measure one or more reflected signals that result from at least a portion of the first transmit signal reflecting off of the reference finger. In some cases, sensor 220 may emit one or more additional transmit signals of one or more frequencies (e.g., a second transmit signal of at least a second frequency different from the first frequency) and again measure one or more reflected signals that are a result of one or more additional transmit signal reflecting off of the reference finger.

In some cases, a biometric model may be generated that characterizes the reference finger when at least the first transmit signal is emitted at the reference finger. For example, the biometric model of the reference finger may include at least one of a transmit signal emitted at the reference finger, or a frequency of a transmit signal emitted at the finger, or a power level or amplitude of a transmit signal emitted at the finger, or a measured reflected signal that reflects off of the reference finger as a result of an emitted transmit signal, or a measured frequency of a reflected signal, or a measured power level of a reflected signal, or any combination thereof. In some cases, the biometric model may include a likely response to sensor 220 emitting one or more transmit signals at a reference finger. For example, the likely response may include expected waveform characteristics of the reflected signals such as the frequency, or amplitude, or wavelength, or period, or phase, or harmonics, or any combination thereof. In some cases, the biometric model, including the one or more attributes of the reflected signals (e.g., reference signals) may be stored locally on a device (e.g., a local memory or storage device associated with ASIC 235) or stored remotely from the device (e.g., in cloud storage), or stored both locally and remotely.

In some cases, the biometric model may characterize a particular reference finger or fingers in general. In some cases, multiple reference fingers (e.g., one or more additional or different reference fingers) may be characterized in similar fashion as described to determine a likely response to the device emitting at least the first transmit signal at fingers in general.

In one example, object 205 may include a reference finger or a finger other than the reference finger. Once a reference finger is characterized, sensor 220 may scan object 205 and ASIC 235 may determine whether a measured attribute resulting from scanning object 205 matches an attribute of the biometric model of the reference finger. For example, sensor 220 may scan object 205 by emitting at least the first transmit signal at object 205, sensor 220 and receiver 245 may receive one or more reflected signals resulting from at least the first transmit signal reflecting off of object 205. In some cases, ASIC 235 may analyze the one or more reflected signals, compare one or more attributes of the reflected signal (e.g., test signal) to the one or more attributes of the biometric model (e.g., one or more stored reference signals), and determine whether the results of scanning object 205 indicates that object 205 is a real finger (e.g., not a spoofed finger).

In some cases, scanning object 205 may include capturing one or more images of object 205, identifying a biometric pattern of object 205 (e.g., fingerprint, vein pattern, iris pattern, retina pattern, face pattern, ear pattern) from the one or more images, and determining whether the identified biometric pattern matches a stored biometric pattern previously captured and stored locally on an associated device or stored remotely from the device (e.g., in cloud storage), or stored both locally and remotely. In some cases, based on the scanning ASIC 235 may identify a second match between a biometric pattern of object 205 (e.g., a first biometric pattern) and a stored biometric pattern associated with the biometric model (e.g., a second biometric pattern).

In some cases, the first biometric pattern may include one or more images of a finger, or of a fingerprint, or of an eye, or of an iris, or of a retina, or of a face, or of a palm, or of an ear, or of a vein, or of a pattern of veins, or any combination thereof. In some cases, the second biometric pattern may include one or more images of a finger, or of a fingerprint, or of an eye, or of an iris, or of a retina, or of a face, or of a palm, or of an ear, or of a vein, or of a pattern of veins, or any combination thereof.

In some cases, a first biometric pattern may include at least one image of a biometric pattern of object 205 captured in conjunction with the scanning of object 205. In some cases, the second biometric pattern may include at least one image of a biometric pattern of a reference object captured prior to the scanning of object 205. In some examples, as indicated above, scanning object 205 may include transmitting one or more frequencies at object 205 and receiving one or more frequencies reflected off of object 205 as a result of transmitting the one or more frequencies. In some cases, scanning object 205 may include capturing one or more images of object 205 before transmitting the one or more frequencies, or after transmitting the one or more frequencies, or while transmitting the one or more frequencies, or any combination thereof.

In one example, object 205 may be a finger. In this example, the first biometric pattern may include a fingerprint of object 205 captured when scanning object 205 and the second biometric pattern may include a fingerprint of the finger captured before scanning object 205. In the example, identifying a match between a first biometric pattern associated with object 205 and a stored second biometric pattern may include identifying a fingerprint from the one or more images of object 205, comparing the identified fingerprint to a stored fingerprint, and determining the identified fingerprint matches the stored fingerprint.

In some examples, ASIC 235 may enable access to a secure resource associated with system 200 based on the first match and the second match. For example, when ASIC 235 determines there is a first match between an attribute of scanning object 205 and an attribute of a previously generated biometric model, and also determines there is a second match between a first biometric pattern associated with scanning object 205 and a stored second biometric pattern, ASIC 235 may enable access to the secure resource. In some cases, the secure resource may include a software resource associated with system 200 (e.g., software application associated with a device such as device 105, mobile application associated with a device such as device 105. etc.), or a firmware resource associated with system 200, or a hardware resource associated with system 200 (e.g., local storage of a device such as device 105, cloud storage associated with a device such as device 105, etc.), or any combination thereof. In some cases, access to the secure resource may include access to a protected user account (e.g., a user account associated with a device such as device 105), or access to an operating system associated with system 200 (e.g., an operating system of a device such as device 105), or any combination thereof. In some cases, ASIC 235 may block access (e.g., continue to block or restrict access) to the secure resource based on an aspect of scanning object 205 not matching the biometric model, or based on the first biometric pattern of object 205 not matching the second biometric pattern.

In some cases, transmitter 240 may generate a second transmit signal of a second frequency and sensor 220 may emit the second transmit signal at object 205. In some cases, sensor 220 may emit the second transmit signal after sensor 220 emits the first transmit signal or sensor 220 may emit the second transmit signal simultaneously while sensor 220 emits the first transmit signal. In some cases, the second frequency may be a different from the first frequency or the same frequency as the first frequency.

In some examples, ASIC 235 may analyze a reflected signal based on a reflection of the first transmit signal off of object 205 and a reflection of the second transmit signal off of object 205 after the reflection of the first transmit signal, or based on the reflection of the first transmit signal combined with the second transmit signal off of object 205. In some cases, ASIC 235 identifying the test signal may be based on ASIC 235 analyzing the reflected signal. In some cases, an aspect of a signal such as the first transmit signal, the second transmit signal, the test signal, or the reference signal includes at least one of a wavelength, or an amplitude, or a period, or a phase, or a signal frequency, or a harmonic frequency, or a signal strength, or an attenuation constant, or a transmit time, or a receive time, or a delay time, or any combination thereof.

In some cases, the reference signal may be associated with a particular material type (e.g., skin tissue, finger tissue, eye tissue, ear tissue, vein tissue, retina tissue, etc.). Thus, in some examples ASIC 235 may identify a material type associated with object 205 based on the test signal matching the reference signal. In some cases, ASIC 235 enabling access to the secure resource may be based on the identified material type matching a certain material type.

In some cases, ASIC 235 may identify a penetration depth that the first transmit signal penetrates object 205 based on comparing an aspect of the test signal to an aspect of the first transmit signal. When a signal (e.g., electromagnetic radiation) is incident on the surface object 205, the signal may be (at least partly) reflected from the surface and there may be a field containing energy transmitted into object 205. Depending on the nature of the material of object 205, the electromagnetic field of the signal might travel relatively far into object 205, or may die out relatively quickly. For a given material, penetration depth may be a function of a wavelength of the incident signal. In some cases, ASIC 235 may determine that the identified penetration depth correlates to the identified material type associated with object 205. In some cases, ASIC 235 enabling access to the secure resource may be based on ASIC 235 determining that the identified penetration depth correlates to the identified material type associated with object 205.

In some examples. ASIC 235 may determine a temperature of object 205 in conjunction with scanning object 205. In some cases, ASIC 235 may determine that the measured temperature of object 205 is within an expected temperature range for object 205 based on determining a material type of object 205 (e.g., an expected temperature of a biometric object such as finger, a face, an ear, an eye, etc.). In some cases, ASIC 235 enabling access to the secure resource may be based on ASIC 235 determining the temperature of object 205 is within the expected temperature range for object 205.

System 200 improves the speed at which anti-spoofing manager 225 and ASIC 235 detect a real biometric object or a spoofed biometric object. For example, anti-spooling manager 225 and. ASIC 235 may detect a real biometric object or a spoofed biometric object within the time it takes transmitter 240 to emit one or two transmit signals (e.g., transmit signals associated with sensor 220 scanning object 205). System 200 improves the accuracy of anti-spoofing manager 225 and ASIC 235 determining whether a scanned object is a real biometric object or a spoofed biometric object (e.g., authentication based on at least a biometric model match and a biometric pattern match).

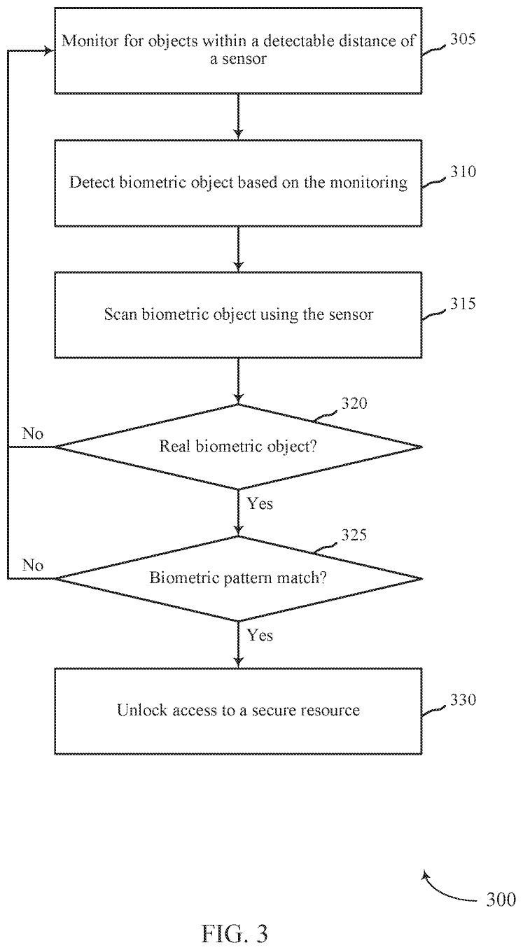

FIG. 3 illustrates an example of a method 300 that supports anti-spoofing detection using a single element transceiver in accordance with aspects of the present disclosure. In some examples, method 300 may implement aspects of system 100.

At 305, method 300 may include monitoring for objects within a detectable distance of a sensor. At 310, method 300 may include detecting an object based on the monitoring.

At 315, method 300 may include scanning the object using the sensor. At 320, method 300 may include determining whether the scanned object is a genuine biometric object (e.g., finger, palm, face, eye, ear, etc.).

When method 300 determines the scanned object is not a genuine biometric object, method 300 may return to monitoring for objects within a detectable distance of a sensor at 305. Conversely, when method 300 determines the scanned object is a genuine biometric object, at 325 method 300 may determine whether a biometric pattern of the scanned object (e.g., fingerprint, eye feature, facial feature, ear feature, palm feature, etc.) matches a stored biometric pattern.

When method 300 determines the biometric pattern of the scanned object matches the stored biometric pattern, at 330 method 300 may include unlocking access to a secure resource. Conversely, when method 300 determines the biometric pattern of the scanned object fails to match the stored biometric pattern, method 300 may continue to block access to the secure resource and may return to monitoring for objects within a detectable distance of a sensor at 305.

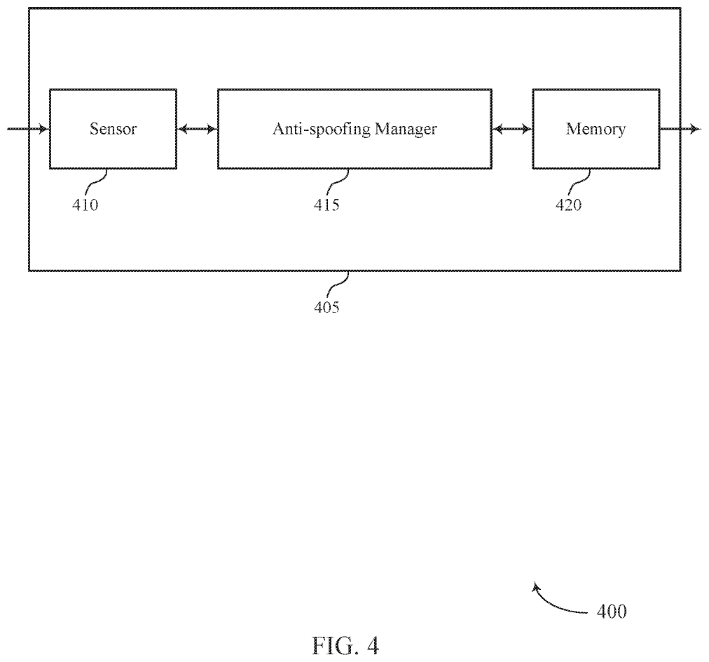

FIG. 4 shows a block diagram 400 of a device 405 that supports anti-spoofing detection using a single element transceiver in accordance with aspects of the present disclosure. The device 405 may be an example of aspects of a device as described herein. The device 405 may include a sensor 410, an anti-spoofing manager 415, and memory 420. The device 405 may also include a processor. Each of these components may be in communication with one another (e.g., via one or more buses).

The sensor 410 may sense and provide information such as sensor data associated with anti-spoofing and liveness detection, etc. Information from sensor 410 may be passed on to other components of the device 405. The sensor 410 may be an example of aspects of the sensor 120 described with reference to FIG. 1. The sensor 410 may communicate over wired or wireless communication links. The sensor 410 may utilize a single antenna or a set of antennas to communicate sensor data wirelessly. Sensor 410 may include or be an example of a sensor for sensing spoofing and detecting liveness associated with detection and analysis of a frequency response (e.g., received waveform) and analysis of biometric patterns.

The anti-spoofing manager 415 may scan, by a sensor associated with the device 405, an object placed within a scanning distance of the sensor, identify a test signal based on scanning the object, compare the test signal to a reference signal, identify a first match between the object and a biometric model based on the comparing, identify, based on the scanning, a second match between a first biometric pattern associated with the object and a stored second biometric pattern, and enable access to a secure resource associated with the device 405 based on the first match and the second match. The anti-spoofing manager 415 may be an example of aspects of the anti-spoofing manager 710 described herein.

The anti-spoofing manager 415, or its sub-components, may be implemented in hardware, code (e.g., software or firmware) executed by a processor, or any combination thereof. If implemented in code executed by a processor, the functions of the anti-spoofing manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The anti-spoofing manager 415, or its sub-components, may be physically located at various positions, including being distributed such that portions of functions are implemented at different physical locations by one or more physical components. In some examples, the anti-spoofing manager 415, or its sub-components, may be a separate and distinct component in accordance with various aspects of the present disclosure. In some examples, the anti-spoofing manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The memory 420 may store information (e.g., sensor information, sensor data, etc.) generated by other components of the device such as anti-spoofing manager 415 or sensor 410. For example, memory 420 may store anti-spoofing information with which to compare an output of anti-spoofing manager 415. Memory 420 may comprise one or more computer-readable storage media. Examples of memory 420 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., anti-spoofing manager 415).

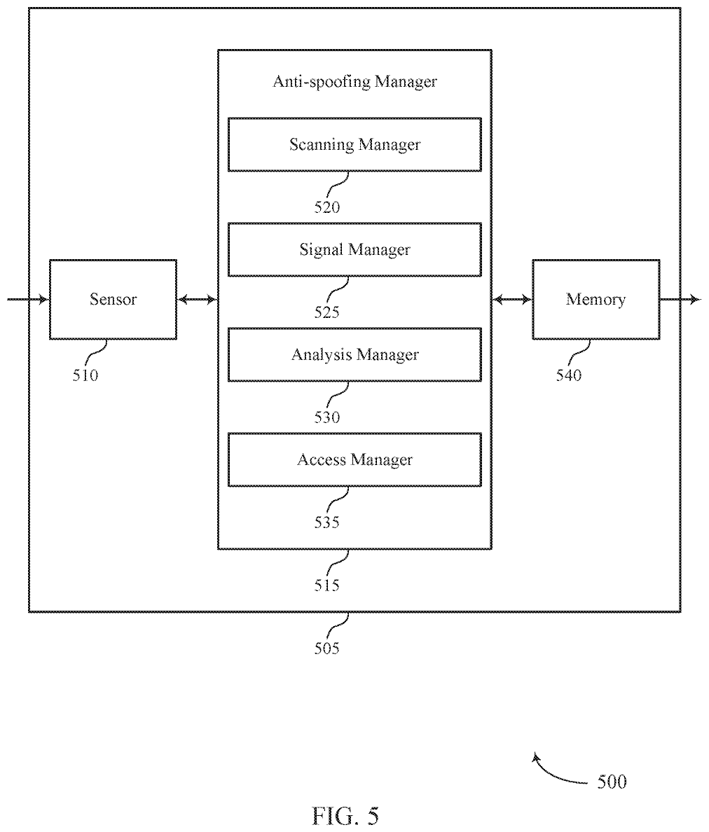

FIG. 5 shows a block diagram 500 of a device 505 that supports anti-spoofing detection using a single element transceiver in accordance with aspects of the present disclosure. The device 505 may be an example of aspects of a device 405 or a device 105 as described herein. The device 505 may include a sensor 510, an anti-spoofing manager 515, and a memory 540. The device 505 may also include a processor. Each of these components may be in communication with one another (e.g., via one or more buses).

The sensor 510 may sense and provide information such as sensor data associated with anti-spoofing and liveness detection, etc. Information from sensor 510 may be passed on to other components of the device 505. The sensor 510 may be an example of aspects of the sensor 120 described with reference to FIG. 1. The sensor 510 may communicate over wired or wireless communication links. The sensor 510 may utilize a single antenna or a set of antennas to communicate sensor data wirelessly. Sensor 510 may include or be an example of a sensor for sensing spoofing and detecting liveness associated with detection and analysis of a frequency response (e.g., received waveform), or analysis of biometric patterns, or both.

The anti-spoofing manager 515 may be an example of aspects of the anti-spoofing manager 415 as described herein. The anti-spoofing manager 515 may include a scanning manager 520, a signal manager 525, an analysis manager 530, and an access manager 535. The anti-spoofing manager 515 may be an example of aspects of the anti-spoofing manager 710 described herein.

The scanning manager 520 may scan, by a sensor associated with the device, an object placed within a scanning distance of the sensor. The signal manager 525 may identify a test signal based on scanning the object.

The analysis manager 530 may compare the test signal to a reference signal, identify a first match between the object and a biometric model based on the comparing, and identify, based on the scanning, a second match between a first biometric pattern associated with the object and a stored second biometric pattern. The access manager 535 may enable access to a secure resource associated with the device based on the first match and the second match.

The memory 540 may store information (e.g., sensor information, sensor data, etc.) generated by other components of the device such as anti-spoofing manager 515 or sensor 510. For example, memory 540 may store anti-spoofing information with which to compare an output of anti-spoofing manager 515. Memory 540 may comprise one or more computer-readable storage media. Examples of memory 540 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., anti-spoofing manager 515).

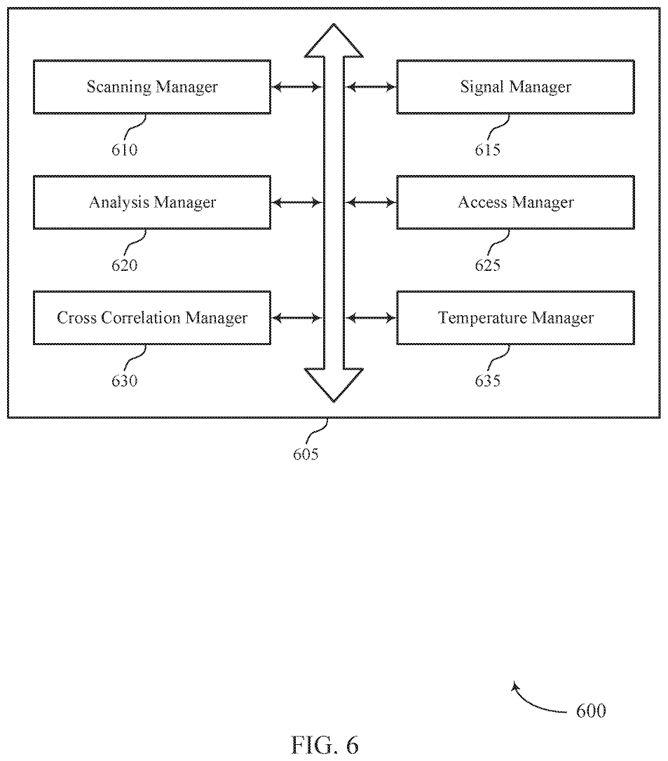

FIG. 6 shows a block diagram 600 of an anti-spoofing manager 605 that supports anti-spoofing detection using a single element transceiver in accordance with aspects of the present disclosure. The anti-spoofing manager 605 may be an example of aspects of an anti-spoofing manager 415, an anti-spoofing manager 515, or an anti-spoofing manager 710 described herein. The anti-spoofing manager 605 may include a scanning manager 610, a signal manager 615, an analysis manager 620, an access manager 625, a cross correlation manager 630, and a temperature manager 635. Each of these modules may communicate, directly or indirectly, with one another (e.g., via one or more buses).

The scanning manager 610 may scan, by a sensor associated with the device, an object placed within a scanning distance of the sensor. The signal manager 615 may identify a test signal based on scanning the object. In some examples, the signal manager 615 may emit a first transmit signal of a first frequency toward the object.

In some examples, the signal manager 615 may emit a second transmit signal of a second frequency at the object, where the second transmit signal is emitted after the first transmit signal or simultaneously with the first transmit signal, and where the second frequency is different from the first frequency. In some examples, the signal manager 615 may identify a penetration depth the first transmit signal penetrates the object based on comparing an aspect of the test signal to an aspect of the first transmit signal.

In some examples, the signal manager 615 may determine that the identified penetration depth correlates to the identified material type associated with the object, where the enabling of access to the secure resource is based on determining the identified penetration depth correlates to the identified material type associated with the object. In some cases, the first biometric pattern includes one or more images of a finger, or of a fingerprint, or of an eye, or of an iris, or of a retina, or of a face, or of a palm, or of an ear, or of a vein, or of a pattern of veins, or any combination thereof, and where the second biometric pattern includes one or more images of a finger, or of a fingerprint, or of an eye, or of an iris, or of a retina, or of a face, or of a palm, or of an ear, or of a vein, or of a pattern of veins, or any combination thereof.

In some cases, an aspect of the first transmit signal, or the second transmit signal, or the test signal, or the reference signal includes at least one of a wavelength, or an amplitude, or a period, or a phase, or a signal frequency, or a harmonic frequency, or a signal strength, or an attenuation constant, or a transmit time, or a receive time, or a delay time, or any combination thereof.

In some cases, a determination to enable the access to the secure resource is made within a time period associated with one or two emissions of at least the first transmit signal. In some cases, the sensor is a piezoelectric copolymer based biometric sensor, where the sensor is integrated in a display of the device. In some cases, the sensor is integrated in a display of the device.

The analysis manager 620 may compare the test signal to a reference signal. In some examples, the analysis manager 620 may identify a first match between the object and a biometric model based on the comparing.

In some examples, the analysis manager 620 may identify, based on the scanning, a second match between a first biometric pattern associated with the object and a stored second biometric pattern. In some examples, the analysis manager 620 may analyze a reflected signal based on a reflection of the first transmit signal off of the object, where identifying the test signal is based on analyzing the reflected signal.

In some examples, the analysis manager 620 may analyze a reflected signal based on a reflection of the first transmit signal off of the object and a reflection of the second transmit signal off of the object after the reflection of the first transmit signal, or based on the reflection of the first transmit signal combined with the second transmit signal off of the object, where identifying the test signal is based on analyzing the reflected signal.

In some examples, the analysis manager 620 may identify a material type associated with the object based on the test signal matching the reference signal, where the reference signal is associated with the identified material type, and where the enabling of access to the secure resource is based on the identified material type matching a certain material type.

The access manager 625 may enable access to a secure resource associated with the device based on the first match and the second match. In some examples, the access manager 625 may block access to the secure resource based on the object not matching the biometric model, or the first biometric pattern of the object not matching the second biometric pattern.

The cross correlation manager 630 may determine a cross-correlation between the reference signal and the test signal to determine a degree of difference between the test signal and the reference signal. In some examples, the cross correlation manager 630 may determine the test signal matches the reference signal when the degree of difference is below a certain threshold.

The temperature manager 635 may identify a temperature of the object in conjunction with scanning the object. In some examples, the temperature manager 635 may determine that the temperature of the object is within an expected temperature range for the object, where the enabling of access to the secure resource is based on determining the temperature of the object is within the expected temperature range for the object.

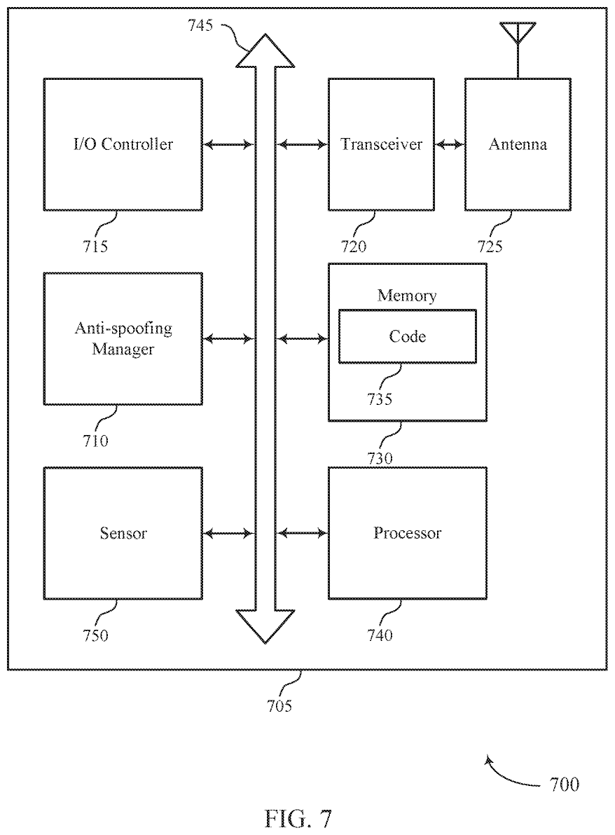

FIG. 7 shows a diagram of a system 700 including a device 705 that supports anti-spoofing detection using a single element transceiver in accordance with aspects of the present disclosure. The device 705 may be an example of or include the components of device 405, device 505, or a device as described herein. The device 705 may include components for bi-directional voice and data communications including components for transmitting and receiving communications, including an anti-spoofing manager 710, an I/O controller 715, a transceiver 720, an antenna 725, memory 730, a processor 740, and a sensor 750. These components may be in electronic communication via one or more buses (e.g., bus 745).

The anti-spoofing manager 710 may scan, by a sensor associated with the device, an object placed within a scanning distance of the sensor, identify a test signal based on scanning the object, compare the test signal to a reference signal, identify a first match between the object and a biometric model based on the comparing, identify, based on the scanning, a second match between a first biometric pattern associated with the object and a stored second biometric pattern, and enable access to a secure resource associated with the device based on the first match and the second match.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links. For example, the transceiver 720 may represent a wireless transceiver and may communicate bi-directionally with another wireless transceiver. The transceiver 720 may also include a modem to modulate emitted signals and provide the modulated signals to the antennas for transmission, and to demodulate signals received from the antennas.

In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device. (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting anti-spoofing detection using a single element transceiver).

The code 735 may include instructions to implement aspects of the present disclosure, including instructions to support anti-spoofing detection. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

The sensor 750 may sense and provide information such as sensor data associated with anti-spoofing and liveness detection, etc. Information from sensor 750 may be passed on to other components of the device 705 via bus 745. The sensor 750 may be an example of aspects of the sensor 120 described with reference to FIG. 1. In some cases, sensor 750 may include a piezoelectric copolymer-based biometric sensor. Sensor 750 may include or be an example of a sensor for sensing spoofing and detecting liveness associated with detection and analysis of a frequency response received waveform) and analysis of biometric patterns. In some cases, sensor 750 may detect and measure a frequency response (e.g., received waveforms) measured in response to firing one or more transmit signals of one or more frequencies at an object under test.

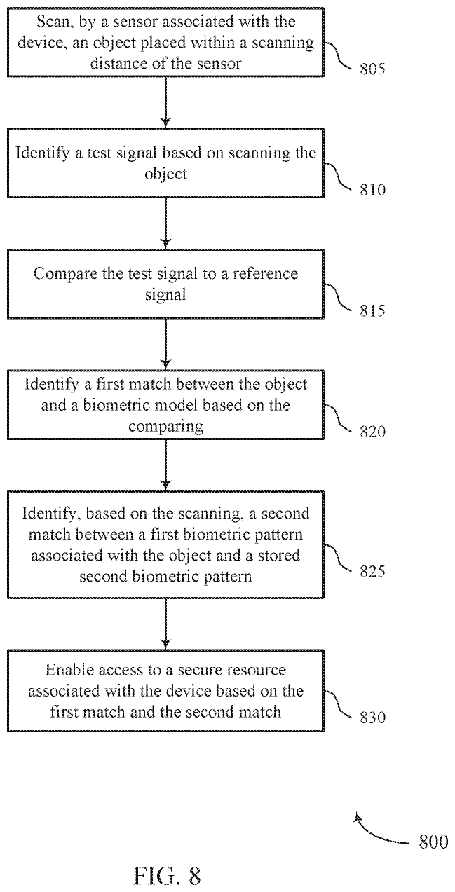

FIG. 8 shows a flowchart illustrating a method 800 that supports anti-spoofing detection using a single element transceiver in accordance with aspects of the present disclosure. The operations of method 800 may be implemented by a device or its components as described herein. For example, the operations of method 800 may be performed by an anti-spoofing manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 805, the device may scan, by a sensor associated with the device, an object placed within a scanning distance of the sensor. The operations of 805 may be performed according to the methods described herein. In some examples, aspects of the operations of 805 may be performed by a scanning manager as described with reference to FIGS. 4 through 7.

At 810, the device may identify a test signal based on scanning the object. The operations of 810 may be performed according to the methods described herein. In some examples, aspects of the operations of 810 may be performed by a signal manager as described with reference to FIGS. 4 through 7.

At 815, the device may compare the test signal to a reference signal. The operations of 815 may be performed according to the methods described herein. In some examples, aspects of the operations of 815 may be performed by an analysis manager as described with reference to FIGS. 4 through 7.

At 820, the device may identify a first match between the object and a biometric model based on the comparing. The operations of 820 may be performed according to the methods described herein. In some examples, aspects of the operations of 820 may be performed by an analysis manager as described with reference to FIGS. 4 through 7.

At 825, the device may identify, based on the scanning, a second match between a first biometric pattern associated with the object and a stored second biometric pattern. The operations of 825 may be performed according to the methods described herein. In some examples, aspects of the operations of 825 may be performed by an analysis manager as described with reference to FIGS. 4 through 7.

At 830, the device may enable access to a secure resource associated with the device based on the first match and the second match. The operations of 830 may be performed according to the methods described herein. In some examples, aspects of the operations of 830 may be performed by an access manager as described with reference to FIGS. 4 through 7.

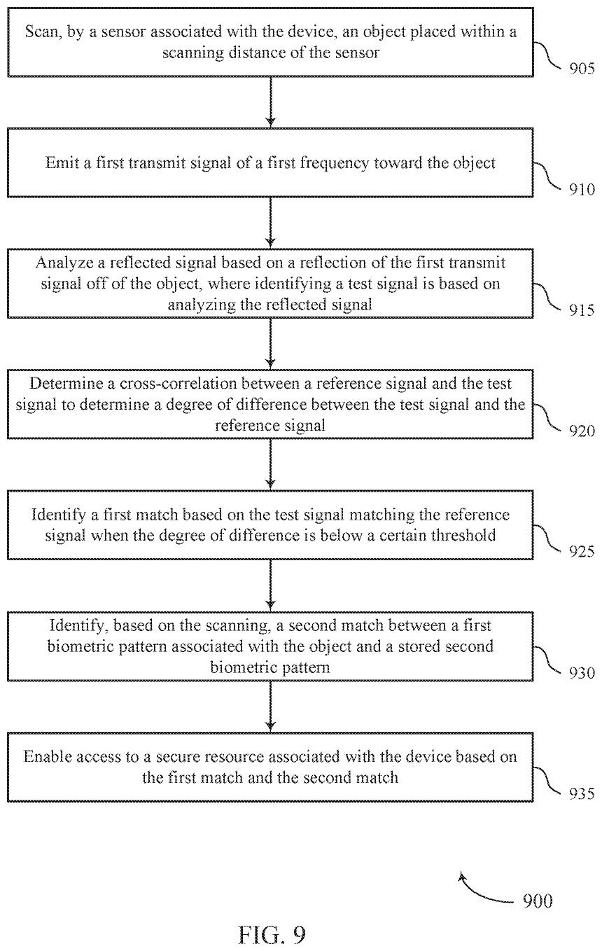

FIG. 9 shows a flowchart illustrating a method 900 that supports anti-spoofing detection using a single element transceiver in accordance with aspects of the present disclosure. The operations of method 900 may be implemented by a device or its components as described herein. For example, the operations of method 900 may be performed by an anti-spoofing manager as described with reference to FIGS. 4 through 7. In some examples, a device may execute a set of instructions to control the functional elements of the device to perform the functions described below. Additionally or alternatively, a device may perform aspects of the functions described below using special-purpose hardware.

At 905, the device may scan, by a sensor associated with the device, an object placed within a scanning distance of the sensor. The operations of 905 may be performed according to the methods described herein. In some examples, aspects of the operations of 905 may be performed by a scanning manager as described with reference to FIGS. 4 through 7.

At 910, the device may emit a first transmit signal of a first frequency toward the object. The operations of 910 may be performed according to the methods described herein. In some examples, aspects of the operations of 910 may be performed by a signal manager as described with reference to FIGS. 4 through 7.

At 915, the device may analyze a reflected signal based on a reflection of the first transmit signal off of the object, where identifying the test signal is based on analyzing the reflected signal. The operations of 915 may be performed according to the methods described herein. In some examples, aspects of the operations of 915 may be performed by an analysis manager as described with reference to FIGS. 4 through 7.

At 920, the device may determine a cross-correlation between the reference signal and the test signal to determine a degree of difference between the test signal and the reference signal. The operations of 920 may be performed according to the methods described herein. In some examples, aspects of the operations of 920 may be performed by a cross correlation manager as described with reference to FIGS. 4 through 7.

At 925, the device may identify a first match based on a determination that the test signal matches the reference signal when the degree of difference is below a certain threshold. The operations of 925 may be performed according to the methods described herein. In some examples, aspects of the operations of 925 may be performed by a cross correlation manager as described with reference to FIGS. 4 through 7.

At 930, the device may identify, based on the scanning, a second match between a first biometric pattern associated with the object and a stored second biometric pattern. The operations of 930 may be performed according to the methods described herein. In some examples, aspects of the operations of 930 may be performed by an analysis manager as described with reference to Wis. 4 through 7.

At 935, the device may enable access to a secure resource associated with the device based on the first match and the second match. The operations of 935 may be performed according to the methods described herein. In some examples, aspects of the operations of 935 may be performed by an access manager as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

The systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for biometric anti-spoofing at a device, comprising:
scanning, by a sensor associated with the device, an object placed within a scanning distance of the sensor;
identifying a test signal based at least in part on scanning the object;
comparing the test signal to a reference signal;
identifying a first match between the object and a biometric model based at least in part on the comparing;
identifying, based at least in part on the scanning, a second match between a first biometric pattern associated with the object and a stored second biometric pattern; and
enabling access to a secure resource associated with the device based at least in part on the first match and the second match.

2. The method of claim 1, wherein scanning the object comprises:
emitting a first transmit signal of a first frequency toward the object; and
analyzing a reflected signal based at least in part on a reflection of the first transmit signal off of the object, wherein identifying the test signal is based at least in part on analyzing the reflected signal.

3. The method of claim 2, further comprising:
emitting a second transmit signal of a second frequency at the object, wherein the second transmit signal is emitted after the first transmit signal or simultaneously with the first transmit signal, and wherein the second frequency is different from the first frequency.

4. The method of claim 3, further comprising:
analyzing a reflected signal based at least in part on a reflection of the first transmit signal off of the object and a reflection of the second transmit signal off of the object after the reflection of the first transmit signal, or based at least in part on the reflection of the first transmit signal combined with the second transmit signal off of the object, wherein identifying the test signal is based at least in part on analyzing the reflected signal.

5. The method of claim 1, wherein comparing the test signal to the reference signal comprises:
determining a cross-correlation between the reference signal and the test signal to determine a degree of difference between the test signal and the reference signal; and
determining the test signal matches the reference signal when the degree of difference is below a certain threshold.

6. The method of claim 1, further comprising:
identifying a material type associated with the object based at least in part on the test signal matching the reference signal, wherein the reference signal is associated with the identified material type, and wherein the enabling of access to the secure resource is based at least in part on the identified material type matching a certain material type.

7. The method of claim 6, further comprising:
identifying a penetration depth the first transmit signal penetrates the object based at least in part on comparing an aspect of the test signal to an aspect of the first transmit signal; and
determining that the identified penetration depth correlates to the identified. material type associated with the object, wherein the enabling of access to the secure resource is based at least in part on determining the identified penetration depth correlates to the identified material type associated with the object.

8. The method of claim 1, further comprising:
identifying a temperature of the object in conjunction with scanning object; and
determining that the temperature of the object is within an expected temperature range for the object, wherein the enabling of access to the secure resource is based at least in part on determining the temperature of the object is within the expected temperature range for the object.

9. The method of claim 1, wherein the first biometric pattern or the second biometric pattern includes one or more images of a finger, or of a fingerprint, or of an eye, or of an iris, or of a retina, or of a face, or of a palm, or of an ear, or of a vein, or of a pattern of veins, or any combination thereof.

10. The method of claim 1, wherein an aspect of the first transmit signal, or the second transmit signal, or the test signal, or the reference signal includes at least one of a wavelength, or an amplitude, or a period, or a phase, or a signal frequency, or a harmonic frequency, or a signal strength, or an attenuation constant, or a transmit time, or a receive time, or a delay time, or any combination thereof.

11. The method of claim 1, wherein a determination to enable the access to the secure resource is made within a time period associated with one or two emissions of at least the first transmit signal.

12. The method of claim 1, further comprising:
blocking access to the secure resource based at least in part on the object not matching the biometric model, or the first biometric pattern of the object not matching the second biometric pattern.

13. The method of claim 1, wherein the sensor is a piezoelectric copolymer based biometric sensor, wherein the sensor is integrated in a display of the device.

14. The method of claim 1, wherein the sensor is integrated in a display of the device.

15. An apparatus for biometric anti-spoofing, comprising:
a processor,
memory coupled with the processor; and
instructions stored in the memory and executable by the processor to cause the apparatus to:
scan, by a sensor associated with the apparatus, an object placed within a scanning distance of the sensor;
identify a test signal based at least in part on scanning the object;
compare the test signal to a reference signal;
identify a first match between the object and a biometric model based at least in part on the comparing;
identify, based at least in part on the scanning, a second match between a first biometric pattern associated with the object and a stored second biometric pattern; and
enable access to a secure resource associated with the apparatus based at least in cart on the first match and the second match.

16. The apparatus of claim 15, wherein the instructions to scan the object are executable by the processor to cause the apparatus to:
emit a first transmit signal of a first frequency toward the object; and
analyze a reflected signal based at least in part on a reflection of the first transmit signal off of the object, wherein identifying the test signal is based at least in part on analyzing the reflected signal.

17. The apparatus of claim 16, wherein the instructions are further executable by the processor to cause the apparatus to:
emit a second transmit signal of a second frequency at the object, wherein the second transmit signal is emitted after the first transmit signal or simultaneously with the first transmit signal, and wherein the second frequency is different from the first frequency.

18. The apparatus of claim 17, wherein the instructions the further executable by the processor to cause the apparatus to:
analyze a reflected signal based at least in part on a reflection of the first transmit signal off of the object and a reflection of the second transmit signal off of the object after the reflection of the first transmit signal, or based at least in part on the reflection of the first transmit signal combined with the second transmit signal off of the object, wherein identifying the test signal is based at least in part on analyzing the reflected signal.

19. An apparatus for biometric anti-spoofing, comprising:
means for scanning, by a sensor associated with the apparatus, an object placed within a scanning distance of the sensor;
means for identifying a test signal based at least in part on scanning the object;
means for comparing the test signal to a reference signal;
means for identifying a first match between the object and a biometric model based at least in part on the comparing;
means for identifying, based at least in part on the scanning, a second match between a first biometric pattern associated with the object and a stored second biometric pattern; and
means for enabling access to a secure resource associated with the apparatus based at least in part on the first match and the second match.

20. The apparatus of claim 19, wherein the means for scanning the object comprises:
means for emitting a first transmit signal of a first frequency toward the object; and
means for analyzing a reflected signal based at least in part on a reflection of the first transmit signal off of the object, wherein identifying the test signal is based at least in part on analyzing the reflected signal.
